(19) United States
(12) Patent Application Publication
(10) Pub. No.: US 2025/0165497 A1
(43) Pub. Date: May 22, 2025

(54) BROWSER-BASED AGGREGATION

(71) Applicant: Plaid Inc., San Francisco, CA (US)

(72) Inventors: Warren Lowell PUTNAM, New York, NY (US); Michael George Del Monte, Garrison, NY (US)

(21) Appl. No.: 19/027,774

(22) Filed: Jan. 17, 2025

Related U.S. Application Data
(63) Continuation of application No. 17/842,444, filed on Jun. 16, 2022, now Pat. No. 12,259,907.
Application No. 17/842,444 is a continuation of application No. 16/042,147, filed on Jul. 23, 2018, now Pat. No. 11,468,085.
(60) Provisional application No. 62/535,859, filed on Jul. 22, 2017.

(51) Int. Cl. G06F 16/27; G06F 16/2455; G06F 16/955; G06F 21/62; G06Q 40/02; G06Q 50/26; H04L 67/141

(52) U.S. Cl. CPC G06F 16/27; G06F 16/24556; G06F 16/955; G06F 21/6245; G06Q 40/02; G06Q 50/265; H04L 67/141

(57) ABSTRACT

A system and method for aggregating account data, and more specifically, a system and method for aggregation of financial account data that provides enhanced privacy and security protections to a user by enabling the user to maintain custody of his or her login credentials. A syncing agent in coordination with a system add-on coordinates log-in to a remote system and storage of session information. Syncing agent utilizes the session agent to retrieve additional information on behalf of the user or perform other tasks on the remote server.

### PRIORITY CLAIM

This application is a continuation of U.S. patent application Ser. No. 17/842,444, filed Jun. 16, 2022, which is a continuation of U.S. patent application Ser. No. 16/042,147, filed Jul. 23, 2018, which claims priority to U.S. Patent Application No. 62/535,859, filed Jul. 22, 2017, the contents of which are incorporated herein by reference in their entireties.

### BACKGROUND

Users with multiple financial institution accounts, such as traditional banking, investments, retirement accounts, and the like, may desire a consolidated balance display from a single source, as opposed to logging in to multiple financial institution sites where they retrieve balance information individually. The difficulty inherent in multiple logins is compounded when the user has a need to check those sources frequently.

Aside from separate logins, traditional methods for monitoring balances and transactions across multiple accounts, all in one place, may require a customer to share sensitive account information in order to permit a third party to aggregate data from each financial institution where an account is held. The customer's login credentials, including user name, password, and perhaps other details such as answers to security questions, may be stored by the third party in order to retrieve related account data from each financial institution.

As an example, a user seeking to aggregate financial institution (“FI”) data through a single third-party source may be required to first submit their online login credentials for each institution to the provider, using a web form or API. The third-party provider may then store the login credentials on its own servers—outside the direct control of the user—and use those stored credentials to log in on the user's behalf when a data update is scheduled or requested by the user.

Many users are reluctant to share login credentials for third-party storage outside their control, raising concerns about the security and integrity of their FI account(s). Many users are further concerned about ceding control to a third-party institution and granting the right to log in without limitation.

The desire for aggregated information from multiple sources is not limited to financial data and similarly applies to any data source that requires user login credentials.

Accordingly, there is a need for an alternate method of aggregating data that does not require a customer to share sensitive account information with a third party.

There is a further need for a data aggregation system in which login credentials are stored with the user or under the user's control.

There is a further need for a data aggregation system in which the user has control over the frequency and nature of logins to his or her accounts held with financial institutions.

### BRIEF DESCRIPTION OF THE DRAWINGS

The features and advantages of the present disclosure will be more fully understood with reference to the following detailed description when taken in conjunction with the accompanying figures, wherein:

FIG. 1 is a logical block diagram describing a preferred embodiment of the present invention.

FIG. 2 is a process diagram describing the steps in an exemplary embodiment of the present invention.

FIG. 3 is a block diagram illustrating exemplary functions of a syncing agent according to embodiments of the present invention.

FIG. 4 describes an exemplary system architecture that may be used to implement one or more illustrative aspects of the present invention.

### SUMMARY

A method is disclosed in which a determination is made whether a user has logged into an information system, via user computing device comprising a system add-on to identify a live session initiated by the customer. In embodiments, the method further comprises receiving, via the add-on, session information transmitted back from the information system, wherein the plugin is configured to copy the session information, and then activate a syncing agent to receive information from the information system, wherein the syncing agent uses session information from the plugin to impersonate the live session initiated by the customer via the browser or mobile application on the user device, and wherein the syncing agent gathers data from the information system relating to at least one of the customer's accounts. In embodiments, data gathered from the information system may be stored for later retrieval by the customer or a third party.

In embodiments of the invention, a non-transitory computer readable medium is provided, having stored thereon, computer executable instructions that, if executed by a computing device, cause the computing device to perform a method comprising determining whether a user has logged into an information system, via user computing device comprising a system add-on to identify a live session initiated by the customer. In embodiments, the computer-executable method further comprises receiving, via the add-on, session information transmitted back from the information system, wherein the plugin is configured to copy the session information, and then activate a syncing agent to receive information from the information system, wherein the syncing agent uses session information to impersonate the live session initiated by the customer via the browser or mobile application on the user device, and wherein the syncing agent gathers data from the information system relating to at least one of the customer's accounts. In embodiments, data gathered from the information system may be stored for later retrieval by the customer or a third party.

In embodiments of the invention, at least one user computing device is provided comprising a processor, memory, and storage, configured to (a) determine whether a user has logged into an information system, and comprising a system add-on to identify a live session initiated by the customer; (b) receive, via the add-on, session information transmitted back from the information system. In embodiments of the invention, a server computer device is provided comprising a syncing agent configured to receive information from the information system, wherein the syncing agent uses session information to impersonate the live session initiated by the customer via the browser or mobile application on the user device, and wherein the syncing agent gathers data from the information system relating to at least one of the customer's accounts. In embodiments, a cloud storage device is provided for storing data gathered from the information system for later retrieval by the customer or a third party.

In embodiments of the invention, the information system may be a financial institution system.

In embodiments of the system, the user computing device may be a tablet computing device or mobile computing device, and may comprise a dedicated application for interacting with the syncing agent.

In embodiments of the invention, the system add-on can be selectively disabled.

In embodiments of the invention the syncing agent comprises a server computing device.

### DETAILED DESCRIPTION

The present invention is directed at a system and method for aggregating account data, and more specifically, a system and method for aggregation of financial account data that provides enhanced privacy and security protections to a user by enabling the user to maintain sole custody of his or her login credentials.

In embodiments of the present invention, a system is provided in which user data—including financial data sourced from financial institutions—may be aggregated to present a consolidated interface, without the user being required to share sensitive account information, or permitting the aggregator to store sensitive account information. In embodiments of the invention, user credentials needed to log into an account are maintained solely with the customer and are not shared through their personal device.

### System Elements

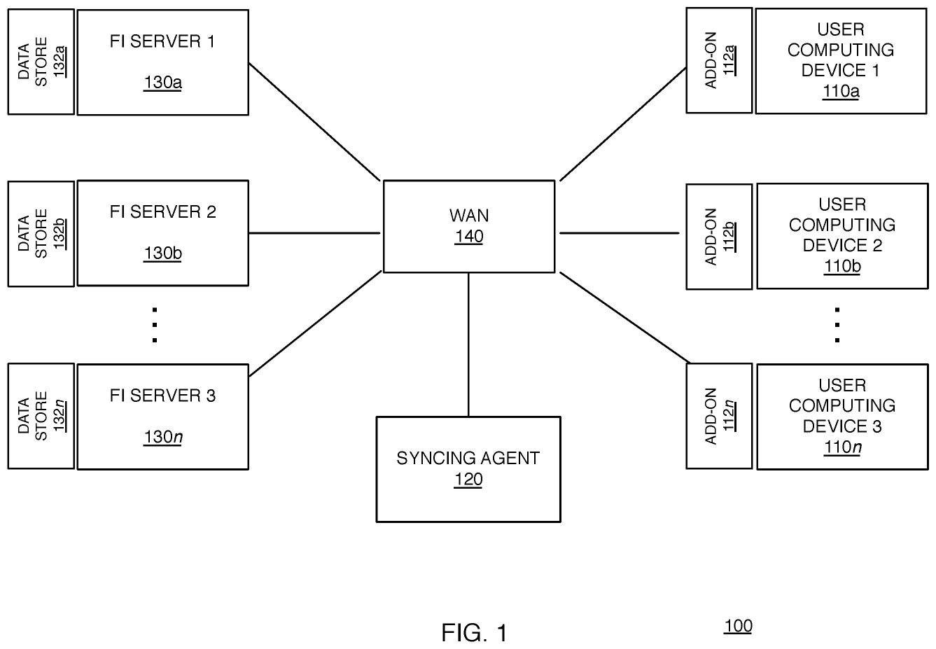

FIG. 1 is a logical block diagram describing a preferred embodiment of the present invention. One or more user computing devices 110a . . . 110n may be in communication with a syncing agent 120 via a wide-area network 140 such as the Internet. A plurality of financial institution web sites 130a . . . 130n may be each associated with a financial institution data store 132a . . . 132n via a network link such as a local area network. Financial institution web sites 130a . . . 130n may similarly be in communication with the syncing agent 120 via a wide-area network such as the Internet.

Each of user computing devices 110a . . . 110n may be associated with system add-ons 112a . . . 112n that, in a preferred embodiment, may be a plug-in that functions as a bridge between the syncing agent 120 and financial institutions 130a . . . 130n. System add-ons 112a . . . 112n may be integrated with computing devices 110a . . . 110n, such as a browser plug-in, API, or special-purpose application, or be physically or logically separate from the computing devices.

FIG. 1 illustrates just one example of a logical framework that may be used, and those of skill in the art will appreciate that the specific implementation is secondary to the functionality that the system components provide.

### Process Flow

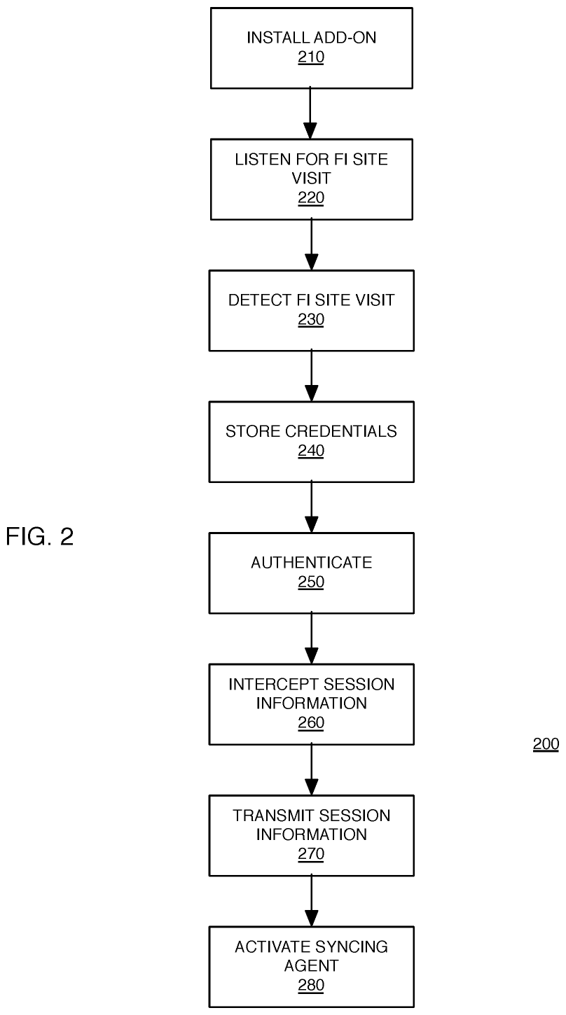

Referring to FIG. 2, a process diagram is shown describing the steps in an exemplary embodiment of the present invention.

In a preferred embodiment, a system add-ons such as a browser plugin is first provided (210) to a user computing device to facilitate exchange with the syncing agent described herein. In embodiments, the browser plugin may be enabled or disabled by the user to meet the user's individual privacy requirements. In an alternate embodiment, a mobile application including necessary plugin code may be opened on the customer device and run in the foreground as would any other app on the device.

When enabled, the plugin is set to a “listening” mode (220) and configured to detect navigation by a user to a FI website. In embodiments, FI websites may include, for example, banking, investment, and retirement accounts, though the system is equally applicable to non-FI information. When the user has navigated to a FI website (230), the user may be prompted to log on as provided by the FI website, and the plugin may coordinate the storage of the user's login credentials (240) on the local user computing device. In embodiments, the plugin may be configured to store login credentials to be entered automatically on the FI website (similar to a password manager browser plugin), but in a preferred embodiment login credentials are not stored so that sensitive personal information associated with an account is maintained solely with the customer, or on the customer's device.

The user's login credentials may then be transmitted to the FI server using the conventional method, wherein the FI authenticates the credentials (250) and sends back a cookie or other session information, which is intercepted (260) by the plugin and saved for later use.

With the cookie or session information in hand following the user's standard login process, the plugin may copy the session information and transmit it to the syncing agent (280) and/or to cloud storage (270) to be stored in a database.

In embodiments, a syncing agent is then activated (280) to receive information from the Fl. In embodiments, the syncing agent may route its communications with the FI through the plugin, which then adds the live session information to those communications in order to use the session established by the user. In other embodiments, the syncing agent may be configured to retrieve cookie or session information from the plugin or database and communicate with the FI directly, to operate as an agent of the user logged in to the current session on the user device.

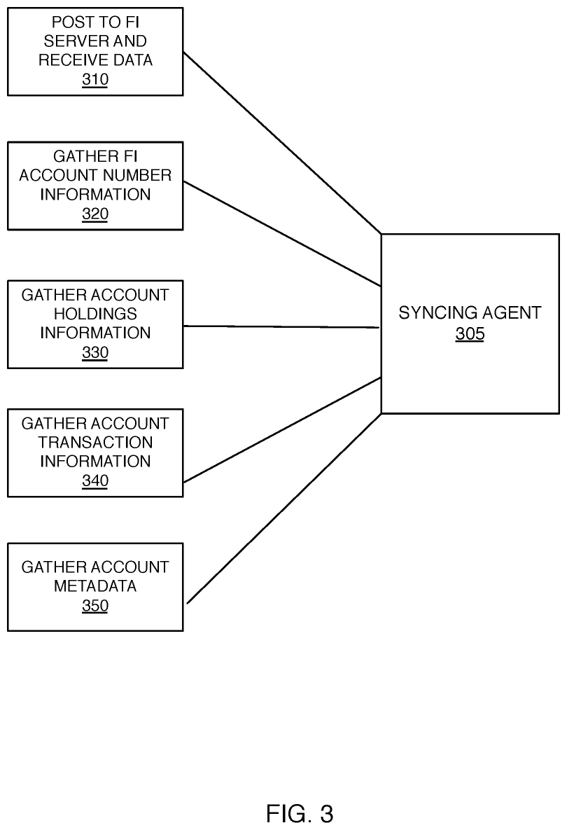

FIG. 3 contains a block diagram illustrating exemplary functions of the syncing agent after the user is logged in to the FI website and syncing agent is in possession of a valid cookie or session information.

In embodiments, the activated syncing agent 305 may:
(a) route communications through the plugin, or make direct posts to the FI web server, using session information, and the FI may send data back to the syncing agent (either via the plugin or directly, thinking that the syncing agent is the browser or mobile app accessing the live session on the user device) (310);
(b) gather data related to account information (account number, account type, etc.) (320);
(c) gather data related to account information holdings/positions/balance information (330);
(d) gather data related to account information transaction history information (340); and
(e) gather data related to account information account “metadata” (bill payment due date, APR, etc.) (350).

The syncing agent may gather data so long as the user remains logged in to a valid session with the FI. Data retrieved by the syncing agent will reside in the cloud database and may be retrieved later on by the user or a third party.

It will be appreciated that the foregoing is merely a summary of all available functions that could be implemented when the syncing agent may use valid cookie or session login information.

### System Architecture

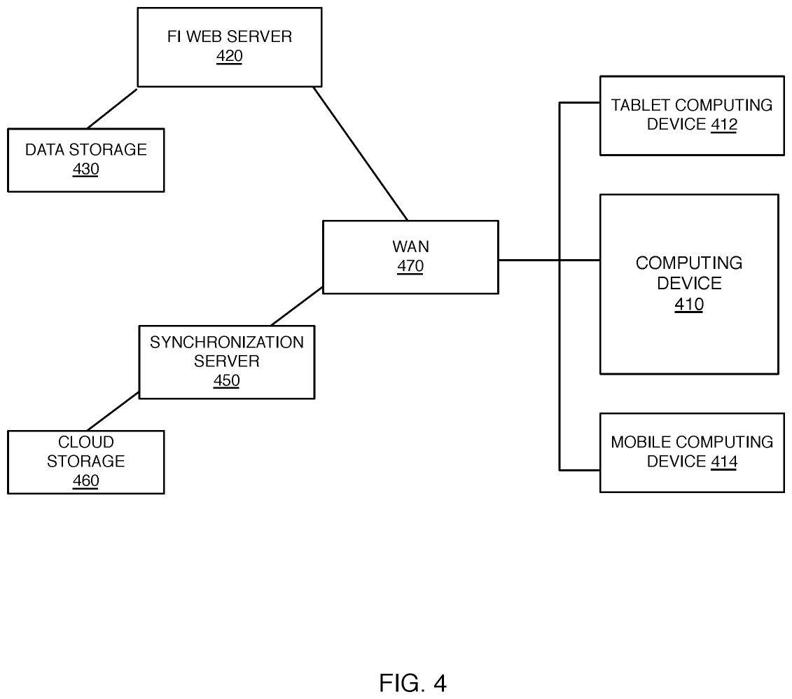

FIG. 4 describes an exemplary system architecture that may be used to implement one or more illustrative aspects described herein. Computer software, hardware, and networks may be utilized in a variety of different system environments, including standalone, networked, remote-access, virtualized, and/or cloud-based environments, among others.

In embodiments, a user may engage with the system via one or more user computing devices connected to the network. Referring to FIG. 4, exemplary computing devices may include personal computer 410. In embodiments other computing devices may be utilized—alternatively or in convert—including tablet computer 412, mobile device 414, and similar devices.

In embodiments, computing device 410 may be a personal computer, a server, a network router, switch or bridge, virtual assistant (e.g., Amazon Alexa, Google Home, Apple HomePod), digital media player (e.g., Amazon Fire, AppleTV, Roku, Google Chromecast, Roku), smartwatch, a set-top box (STB), gaming system, or any machine capable of executing a set of instructions (sequential or otherwise) that specify actions to be taken by that computing device.

While only a collection of computing devices are illustrated, the term “computing device” should be taken to include any collection of computing devices that individually or jointly execute a set (or multiple sets) of instructions to perform any one or more of the methodologies discussed herein.

In embodiments, the computing device may be connected (e.g., networked) to other machines in a LAN, an intranet, an extranet, a WiFi network, a cellular network, or the Internet (WAN) 470. In embodiments, computing device 410 may be provided with a web browser for facilitating connections over the network.

In embodiments of the present invention, a browser plugin may be provided on computing device 410 to carry out the steps described in FIGS. 2-3. The term “plugin” refers to any software component that extends the functionality of the user's existing system, and may include browser plugins, extensions, system services, and other software- and hardware-based add-ons.

In further embodiments, computing device 410 may be provided with an app that implements the methodologies discussed herein. In embodiments of the invention, a software development kit (“SDK”) may be provided to facilitate development of mobile apps (or other software) to run operate with the system of the present invention.

In embodiments, the system of the present invention may include one or more web servers 420, each connected to a financial information database or data storage device 430. In embodiments, the computing device may be connected (e.g., networked) to other machines in the same manner as the computing device 410, namely, in a LAN, an intranet, an extranet, a WiFi network, a cellular network, or the Internet.

In embodiments, the system of the present invention may include a synchronization server 450 and associated cloud storage 460. The synchronization server 450 may contain code that implements the synchronization steps shown in FIGS. 2-3 and discussed herein. Cloud storage 460 may be a data storage device, which can be configured as a server computing service, for receiving user data during synchronization. Synchronization server 460 may function as an intermediary system between a user and financial institution, and coordinate the steps of accessing, storing, and processing user FI data.

As shown in FIG. 4, various nodes including those associated with a network—including 410, 420, 430, 440—may be interconnected using a wide area network (WAN) 470, such as the Internet. Other networks may also or alternatively be used, including private intranets, corporate networks, LANs, metropolitan area networks (MAN) wireless networks, personal networks (PAN), and the like. Network 470 is for illustration purposes and may be replaced with fewer or additional computer networks. A local area network (LAN) may have one or more of any known LAN topology and may use one or more of a variety of different protocols, such as Ethernet. Devices—including 410, 420, 430, 440—may be connected to one or more of the networks via ethernet cable, coaxial cable, fiber optic cable, wireless communication protocols utilizing radio waves (including, e.g., WiFi and Bluetooth), or other communication media.

It will be understood that the term “network” refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

It will be understood by those of ordinary skill in the art that computing devices, server computing devices, and data storage may be combined on the same physical machines, and retain separate virtual or logical addresses, or may reside on separate physical machines. FIG. 4 illustrates just one example of a network architecture that may be used, and those of skill in the art will appreciate that the specific network architecture and data processing devices used may vary, and are secondary to the functionality that they provide, as further described herein. For example, services provided by web server 420 and data server 430 may be combined on a single server.

Each component node on the network—including computing devices 410, 412, 414 and server computing devices 420, 450—may be any type of known computer, server, or data processing device. User computing devices and servers may include a processor controlling overall operation of the computing device or server. These devices may further include random access memory (RAM), read-only memory (ROM), network interface, input/output interfaces (e.g., keyboard, touchscreen, mouse, display, printer, etc.), and memory.

Memory may also store data used in performance of one or more aspects described herein, including the databases associated with the servers discussed herein. Information can be stored in a single database, or separated into different logical, virtual, or physical databases, depending on system design. Those of skill in the art will appreciate that the functionality of user computing devices and servers described herein may be spread across multiple data processing devices, for example, to distribute processing load across multiple computers, to segregate transactions based on geographic location, user access level, quality of service, or other factors.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting or markup language. The computer executable instructions may be stored on a computer-readable medium such as a nonvolatile storage device. Any suitable computer-readable storage media may be utilized, including hard disks, CD-ROMs, optical storage devices, magnetic storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

Although the foregoing invention has been described in detail for purposes of clarity of understanding, it will be apparent that certain changes and modifications may be practiced within the scope of the appended claims. Therefore, the described embodiments should be taken as illustrative and not restrictive, and the invention should not be limited to the details given herein but should be defined by the following claims and their full scope of equivalents.

1. (canceled)

2. A method comprising:
enabling, by a user device, a plugin on the user device;
detecting, by the user device using the plugin, navigation to an institution website;
transmitting, by the user device based on the navigation to the institution website, login credentials of a user to an institution server associated with the institution website;
receiving, by the user device using the plugin and based on the login credentials being authenticated, session information from the institution server;
activating, by the user device using the plugin, a syncing agent to receive information from the institution server by transmitting the session information to the syncing agent; and
routing, by the user device using the plugin, communications between the syncing agent and the institution server.

3. The method of claim 2, wherein the session information is a cookie.

4. The method of claim 2, further comprising:
adding live session information to the communications.

5. The method of claim 2, wherein the navigation to the institution website is detected when the plugin is set to a listening mode.

6. The method of claim 2, further comprising:
storing the login credentials.

7. The method of claim 2, further comprising:
copying, using the plugin, the session information.

8. The method of claim 2, wherein the plugin is a browser plugin.

9. A user device, comprising:
one or more memories; and
one or more processors, coupled to the one or more memories, configured to:
enable a plugin;
detect, using the plugin, navigation to an institution website;
transmit, based on the navigation to the institution website, login credentials of a user to an institution server associated with the institution website;
receive, using the plugin and based on the login credentials being authenticated, session information from the institution server;
transmit, using the plugin, the session information to a syncing agent to activate the syncing agent to receive information from the institution server; and
route, using the plugin, communications between the syncing agent and the institution server.

10. The user device of claim 9, wherein the session information is a cookie.

11. The user device of claim 9, wherein the one or more processors are further configured to:
add live session information to the communications.

12. The user device of claim 9, wherein the one or more processors, to detect the navigation to the institution website, are configured to:
detect the navigation to the institution website when the plugin is set to a listening mode.

13. The user device of claim 9, wherein the one or more processors are further configured to:
store the login credentials.

14. The user device of claim 9, wherein the one or more processors are further configured to:
copy, using the plugin, the session information.

15. The user device of claim 9, wherein the plugin is a browser plugin.

16. A non-transitory computer-readable medium storing a set of instructions, the set of instructions comprising:
one or more instructions that, when executed by one or more processors of a user device, cause the user device to:
enable a plugin;
detect, using the plugin, navigation to an institution website;
transmit, based on the navigation to the institution website, login credentials of a user to an institution server associated with the institution website;
receive, using the plugin and based on the login credentials being authenticated, session information from the institution server;
transmit, using the plugin, the session information to a syncing agent to activate the syncing agent to receive information from the institution server; and
route, using the plugin, communications between the syncing agent and the institution server.

17. The non-transitory computer-readable medium of claim 16, wherein the session information is a cookie.

18. The non-transitory computer-readable medium of claim 16, wherein the one or more instructions further cause the user device to:
add live session information to the communications.

19. The non-transitory computer-readable medium of claim 16, wherein the one or more instructions, to cause the user device to detect the navigation to the institution website, are configured to cause the user device to:
detect the navigation to the institution website when the plugin is set to a listening mode.

20. The non-transitory computer-readable medium of claim 16, wherein the one or more instructions further cause the user device to:
copy, using the plugin, the session information.

21. The non-transitory computer-readable medium of claim 16, wherein the plugin is a browser plugin.
